(19) United States
(12) Patent Application Publication
(10) Pub. No.: US 2019/0229383 A1
(43) Pub. Date: Jul. 25, 2019

(54) Electric Energy Store Comprising Energy Storage Cells, the Side Surfaces of Which Are Provided with a Pattern

(71) Applicant: Bayerische Motoren Werke Aktiengesellschaft, Muenchen (DE)

(72) Inventors: Juergen HILDINGER, Hoehenkirchen-Siegertsbrunn (DE); Sebastian SCHARNER, Tuerkenfeld (DE)

(21) Appl. No.: 16/374,843

(22) Filed: Apr. 4, 2019

Related U.S. Application Data
(63) Continuation of application No. PCT/EP2017/072710, filed on Sep. 11, 2017.

(30) Foreign Application Priority Data
Oct. 5, 2016 (DE) 10 2016 219 286.8

(51) Int. Cl. H01M 10/6555; H01M 10/613; H01M 10/6567; H01M 2/10; H01M 10/625

(52) U.S. Cl. CPC H01M 10/6555; H01M 10/613; H01M 10/625; H01M 2/1077; H01M 10/6567

(57) ABSTRACT

An energy store has a plurality of electric energy storage cells, which are connected electrically in series or in parallel and are combined to form an energy storage module. Interspaces are formed between the energy storage cells and into which coolants or refrigerants can be introduced. In each case, side surfaces of the energy storage cells that bound the interspaces are provided with a regular pattern, which is formed in the shape of an elevation or depression with respect to the remaining surface of the relevant side surface.

### CROSS REFERENCE TO RELATED APPLICATIONS

This application is a continuation of PCT International Application No. PCT/EP2017/072710, filed Sep. 11, 2017, which claims priority under 35 U.S.C. § 119 from German Patent Application No. 10 2016 219 286.8, filed Oct. 5, 2016, the entire disclosures of which are herein expressly incorporated by reference.

This application contains subject matter related to U.S. applications Ser. Nos. ______(Atty Docket No. 080437.PB997US), entitled “Stored Electrical Energy Source Having Cooling Plates Arranged between the Cells for Emergency Cooling,” and ______(Atty Docket No. 080437.PB998US), entitled “Stored Electrical Energy Source Having an Emergency Cooling Device” filed on even date herewith.

### BACKGROUND AND SUMMARY OF THE INVENTION

The invention relates to an energy store consisting of energy storage cells between which intermediate spaces are formed that serve to cool the energy storage cell.

As things currently stand, electrical traction energy stores having a high voltage level are predominantly used for electromobility. Such energy stores or high-voltage stores predominantly use lithium-ion stores that have various design possibilities. In the technical field, there is a prevailing tendency to develop lithium-ion cells having an increasingly higher energy density. The thermal stability of many lithium-ion cells however behaves in a manner inversely proportional to the stored amount of energy per unit of volume (energy density). In such high-voltage stores, an energy storage cell that experiences a short circuit internal to the cell may exponentially release heat (what is called a thermal event). However, the amount of heat arising in this process is not enough to likewise excite a thermal event in the adjacent cell: as long as the energy density does not exceed 130-150 Wh/kg and the thermal stability limit is high enough, a thermal event remains restricted to the cell with a short circuit internal to the cell and does not propagate further into the store. In future stores, it is the intention for the energy density of energy storage cells to be increased up to 200 Wh/kg and more. The amount of heat in a thermal event in such an energy storage cell could then be enough to transition to adjacent cells. To prevent this, additional measures have to be provided in the energy store in order to also ensure its safety in these critical situations.

There is therefore a need for safety precautions for future high-voltage stores that will have a higher energy density.

One object of the invention is to provide an energy store that meets higher safety requirements. This object is achieved by an energy store, as well as a motor vehicle equipped with an energy store, having a plurality of electrical energy storage cells that are electrically connected in series or in parallel and are combined so as to form an energy storage module. Intermediate spaces are formed between the energy storage cells into which coolant or cooling medium is able to be introduced. The side faces, delimiting the intermediate space, of the energy storage cells are each provided with a regular pattern which is designed in the form of an elevation or depression with respect to the rest of the surface of the side face in question.

The invention may be used in energy storage modules having an emergency cooling function, in which an energy storage module is only cooled upon a thermal event. Likewise, the invention may be used in a cooling system of the energy storage module or of an energy storage cell during normal operation.

According to one exemplary embodiment of the invention, an energy store is provided, having a plurality of electrical energy storage cells that are electrically connected in series or in parallel and are combined so as to form an energy storage module, and intermediate spaces, formed between the energy storage cells and into which coolant or cooling medium is able to be introduced, wherein the side faces, delimiting the intermediate space, of the energy storage cells are each provided with a regular pattern which is designed in the form of an elevation or depression with respect to the rest of the surface of the side face in question. These side faces are in particular provided completely and continuously with the pattern. Preferably, only these side faces (and not the other faces of the energy storage cell) are provided with the pattern. The invention unburdens the tie rod of energy storage modules and may lead to weight savings there. Furthermore, the use of the pattern may increase the heat exchange surface of the cell, as a result of which the efficiency of the emergency cooling device is improved. The invention contains a future capability for existing energy storage cell formats since future cell chemistries with even higher energy densities are able to be controlled through improved heat dissipation.

According to a further exemplary embodiment of the invention, the intermediate spaces each have a support frame that spaces adjacent energy storage cells. These support frames ensure stable stacking and alignment of the energy storage modules.

According to a further exemplary embodiment of the invention, the elevation or depression of the pattern has an extent of between 0.1 and 3 mm. This means the extent perpendicular to the rest of the surface on which the pattern is formed. This dimension has proven to be advantageous with respect to compactness and stability.

According to a further exemplary embodiment of the invention, the pattern is formed by embossing.

According to a further exemplary embodiment of the invention, the pattern is formed by laser ablation.

According to a further exemplary embodiment of the invention, the pattern is a honeycomb pattern.

According to a further exemplary embodiment of the invention, the pattern consists of waved lines running in parallel.

According to a further exemplary embodiment of the invention, the pattern is a checkerboard pattern.

According to a further exemplary embodiment of the invention, the pattern is a brick pattern.

The invention furthermore provides a motor vehicle having such an energy store.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic structure of an energy store according to an embodiment of the invention.

FIG. 2 schematically shows a support frame between adjacent energy storage cells of the energy store from FIG. 1.

FIG. 3 shows an energy storage cell with a pattern to be applied.

FIGS. 4A to 4F show further patterns to be applied to the energy storage cells.

### DETAILED DESCRIPTION OF THE DRAWINGS

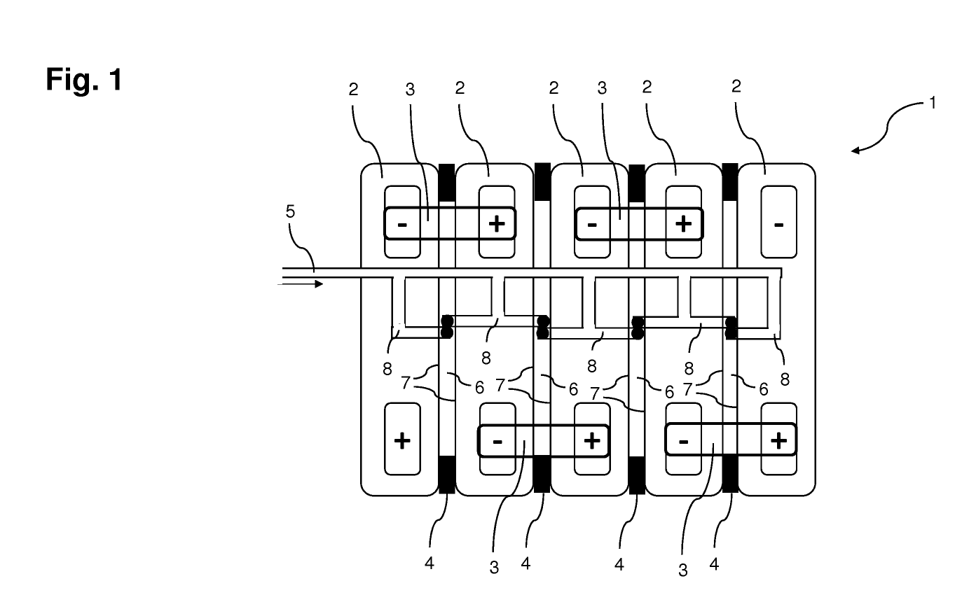

FIG. 1 shows a schematic structure of an electrical energy store 1. It comprises a plurality of electrical energy storage cells 2, which are preferably lithium-ion cells. The energy storage cells 2 are preferably what are known as hard-case cells. These are prismatic cells having an, in particular, torsion-resistant metal housing, in particular made from aluminum. This metal housing is not a composite material, but rather is exclusively metal. The metal housing is closed off using a laser welding method.

The plurality of energy storage cells 2 are combined so as to form an energy storage module, wherein the individual energy storage cells 2 are electrically connected to one another in series or in parallel, preferably in series, as illustrated in FIG. 1, by way of cell connectors 3. The cell connectors 3 are configured as plate-shaped connecting busbars that accordingly connect the poles of the individual energy storage cells 2 to one another. An intermediate space 6 is in each case formed between each two adjacent energy storage cells 2, which intermediate space is formed by opposing side faces 7 of the energy storage cells 2, between which the intermediate space 6 is formed. A support frame 4 is arranged in each of the intermediate spaces 6 and spaces two adjacent energy storage cells 2 from one another.

Preferably, only in the case of an emergency cooling requirement (thermal event), coolant is able to be fed directly to one or more coolant lines 8 via a coolant feed line 5. A coolant feed during normal operation is also contemplated. Water, CO₂, a fluorinated ketone, a fluorinated ether and/or a hydrofluoroether may be used as the coolant, for example. A specific coolant line 8 guides the coolant into the intermediate space 6 associated with this coolant line 8, as a result of which the energy storage cell 2 associated with the coolant line 8 is cooled. An energy storage cell 2 that is heating exponentially is then able to be cooled down using the non-combustible coolant. An emergency cooling device in this case itself recognizes whether and which cell has to be cooled, a power supply not being necessary. To this end, the coolant lines 8 are provided with valves or emergency closures, not shown, that allow a flow of coolant only above a specific limit temperature, in particular 100 to 130° C., and therefore block a flow of coolant up to this temperature.

A respective single valve or emergency closure is provided per energy storage cell 2, which valve or emergency closure blocks a flow of coolant through the associated coolant line 8 during normal operation of the energy storage cells 2 and allows a flow of coolant when the limit temperature of the associated energy storage cell 2 is exceeded. The coolant lines 8 are connected to the coolant feed line 5 in parallel with one another. The coolant lines 8 lead into one or two intermediate spaces 6 that bear on the energy storage cell 2 associated with the coolant line 8. More precisely, the two outer energy storage cells 2 of the energy storage module are provided with an intermediate space 6 only on their sides facing toward the center of the energy storage module. Therefore, the coolant lines 8 of the two outer energy storage cells 2 lead directly to these intermediate spaces 6. The energy storage cells 2 arranged between two energy storage cells 2 (the inner energy storage cells) are provided in each case on both sides with intermediate spaces 6, wherein two adjacent energy storage cells 2 divide the intermediate space 6 situated between them or this intermediate space 6 is associated with both energy storage cells 2. The coolant lines 8 of these inner energy storage cells 2 branch off, wherein a respective branch leads to one of the two intermediate spaces 6 that bears on the energy storage cell 2 associated with the coolant line 8 in question.

If the temperature of an energy storage cell 2 in question now exceeds the limit temperature, then the coolant line 8 associated with this energy storage cell 2 opens by way of the valve or of the emergency closure, such that coolant is able to flow out of the coolant feed line 5 into the intermediate spaces 6, more precisely into the respective interior of the support frame 4, which bear on the energy storage cell 2 in question, via the coolant line 8, which is now open. To save weight and structural space, the coolant reservoir is ideally dimensioned for the cooling system of an energy storage cell 2. In this case, each energy storage cell 2 in the energy store 1 is able to be served by the cooling system.

It would also be possible to incorporate the described emergency cooling system into a cooling circuit that is provided for the air conditioning of a vehicle passenger compartment or for the cooling of vehicle components (for example for the regular cooling of the energy store). The emergency cooling system may therefore be integrated into an existing store cooling system, that is to say provided in addition thereto, and use the coolant (for example cooling medium) in the existing store cooling system in an emergency.

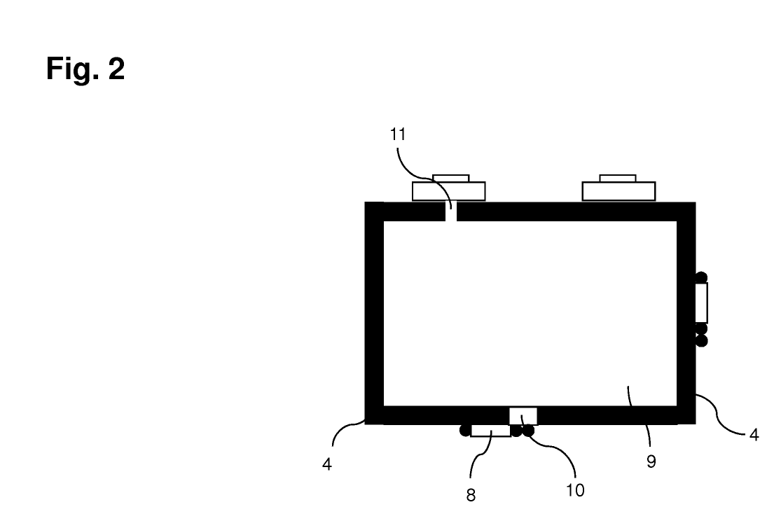

FIG. 2 schematically shows a support frame 4. This is preferably a rectangular frame that is either configured in one part and therefore has a closed rectangular frame form, or that forms this frame form in several parts and is constructed for example from two halves. A cavity 9 is formed inside the support frame 4, into which cavity the coolant or cooling medium is able to be introduced from the coolant line 8 via an input 10 and out of which cavity the coolant or cooling medium is able to be dissipated via an output 11. By way of the cavity 9, the coolant or cooling medium is able to be distributed over the opposing side faces 7 of the energy storage cells 2, which are provided with a pattern for the sake of improved heat transfer and stiffness, as described below.

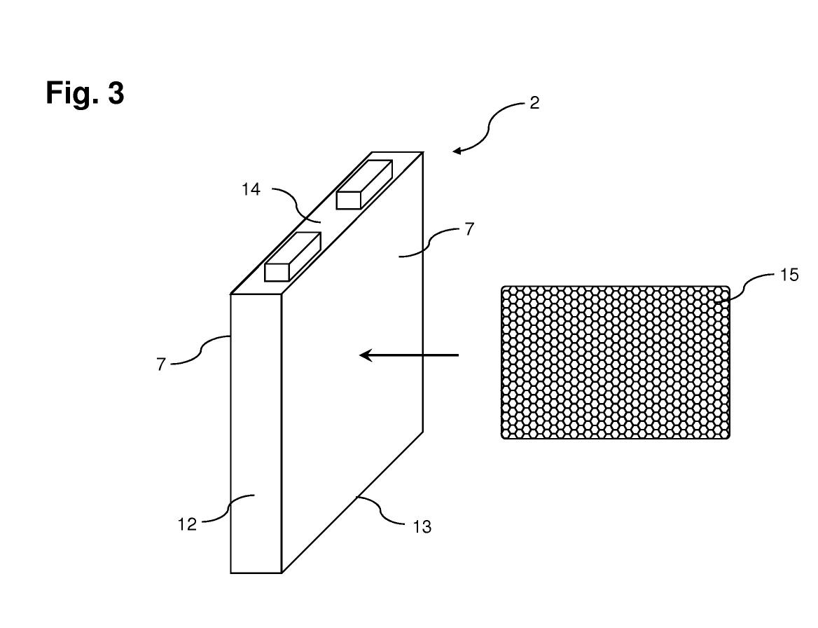

FIG. 3 schematically shows an energy storage cell 2 according to an embodiment of the invention. The energy storage cell 2 comprises what is known as a cell container, which has two side faces 7 (the two sides having the largest area), two end faces 12 and a bottom face 13. This cell container is preferably designed in one piece, in particular so as to be monolithic. Such a cell container is manufactured through deep drawing or extrusion of aluminum. A cell cover 14 with the positive and negative pole arranged therein is fastened to the cell container, in particular by laser welding.

The side faces 7, at least those side faces 7 that delimit an intermediate space 6, are provided with a pattern. To increase the stiffness of the two side faces 7 and at the same time to increase the heat exchange surface required for the emergency cooling of the energy storage cell 2, these side faces 7 are provided with a pattern that is designed in the form of an elevation or depression (for example positive or negative embossing). The pattern preferably has the geometry of a honeycomb structure, as illustrated on the right-hand side of FIG. 3.

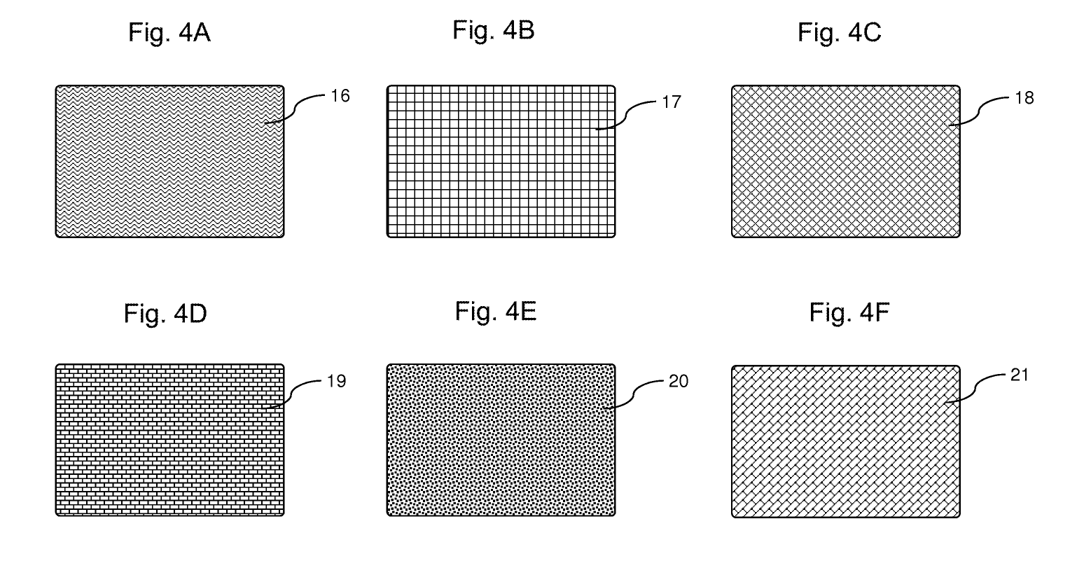

FIGS. 4A to 4F show further patterns as may be provided on the side faces 7. These structures may additionally serve to control the flow direction and velocity of the coolant or cooling medium. The depth of the pattern (FIG. 3-4F) is between 0.1 mm and 3 mm. The diameter of the structural units (for example honeycombs) is between 0.1 mm and 1 cm. The patterns or the surface structure may be introduced for example by embossing during the manufacturing process or subsequently through etching or laser ablation into the surface of the cell housing. The housing may thereafter be painted so as to make it electrically insulating.

FIG. 4A shows in detail a pattern 16 that consists of wavy lines running in parallel. Said wavy lines run parallel to a longitudinal direction of the energy storage cell 2, the longitudinal direction extending along the longest edge of the energy storage cell 2.

FIG. 4B shows a pattern 17 in the form of a checkerboard pattern, which consists of a plurality of straight lines running parallel to the longitudinal direction and a plurality of lines running perpendicular thereto. The distances between the lines are preferably identical.

FIG. 4C shows a pattern 18 in the form of a checkerboard pattern, which consists of a plurality of straight lines running in parallel and offset by 45° to the longitudinal direction and a plurality of lines running perpendicular thereto. The distances between the lines are preferably identical.

FIG. 4D shows a pattern 19 in the form of a brick pattern, which consists of a plurality of straight lines running parallel to the longitudinal direction and lines running perpendicular thereto, which extend between two adjacent lines and in so doing form a series of bricks. In this case, the perpendicularly running lines are arranged at regular distances from one another. Two adjacent series of bricks are offset by half the distance.

FIG. 4E shows a pattern 20 in the form of a regular point pattern.

FIG. 4F shows a brick pattern as described in connection with FIG. 4D, wherein the brick pattern in FIG. 4F is rotated by 45° with respect to the longitudinal direction.

Although the invention has been illustrated and described in detail in the drawings and the above description, this illustration and description should be understood to be illustrative or exemplary and not to be restrictive, and it is not intended to restrict the invention to the disclosed exemplary embodiments. The mere fact that particular features are cited in various dependent claims is not intended to indicate that a combination of these features could not also be utilized to advantage.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy store, comprising:
a plurality of electrical energy storage cells electrically connected in series or in parallel and combined to form an energy storage module; and
intermediate spaces formed between the energy storage cells and into which coolant or a cooling medium is introducible, wherein
in each case, side faces of the energy storage cells that bound the intermediate spaces are provided with a regular pattern formed in a shape of an elevation or depression with respect to a remaining surface of the respective side face.

2. The energy store as claimed in claim 1, wherein
the intermediate spaces each have a support frame that spaces adjacent energy storage cells.

3. The energy store as claimed in claim 2, wherein
the elevation or depression of the regular pattern has an extent of between 0.1 and 3 mm.

4. The energy store as claimed in claim 1, wherein
the elevation or depression of the regular pattern has an extent of between 0.1 and 3 mm.

5. The energy store as claimed in claim 1, wherein
the regular pattern is an embossed pattern.

6. The energy store as claimed in claim 1, wherein
the regular pattern is a laser ablated pattern.

7. The energy store as claimed in claim 1, wherein
the regular pattern is a honeycomb pattern.

8. The energy store as claimed in claim 1, wherein
the regular pattern comprises wavy lines running in parallel.

9. The energy store as claimed in claim 1, wherein
the regular pattern is a checkerboard pattern.

10. The energy store as claimed in claim 1, wherein
the regular pattern is a brick pattern.

11. A motor vehicle, comprising an energy store as claimed in claim 1.
